(19) United States
(12) Patent Application Publication
(10) Pub. No.: US 2015/0165998 A1
(43) Pub. Date: Jun. 18, 2015

(54) SIDE COLLISION DETECTION DEVICE FOR VEHICLE

(71) Applicant: DENSO CORPORATION, Kariya-city (JP)

(72) Inventor: Masahiko IMOTO, Kariya-city (JP)

(21) Appl. No.: 14/565,978

(22) Filed: Dec. 10, 2014

(30) Foreign Application Priority Data
Dec. 13, 2013 (JP) 2013-257532

(51) Int. Cl. B60R 21/013

(52) U.S. Cl. CPC B60R 21/013; B60R 2021/0006

(57) ABSTRACT

A side collision detection device for a vehicle includes a hollow detection tube member, a pressure sensor, and a control device. The detection tube member is arranged in a door of the vehicle. The door includes a rigid member that is provided to extend in a front-rear direction of the vehicle. The detection tube member is arranged along an outer surface of the rigid member in a width direction of the vehicle. The pressure sensor detects a pressure in the detection tube member. The control device detects a collision of an object with the door based on a result of the detection of the pressure by the pressure sensor.

### CROSS REFERENCE TO RELATED APPLICATION

This application is based on Japanese Patent Application No. 2013-257532 filed on Dec. 13, 2013, the disclosure of which is incorporated herein by reference.

### TECHNICAL FIELD

The present disclosure relates to a side collision detection device for a vehicle that detects an occurrence of a collision on a side surface of the vehicle.

### BACKGROUND

Conventionally, there is a vehicle including an airbag device for an occupant of the vehicle for alleviating an impact on the occupant at the time of a collision accident of the vehicle. This vehicle includes a collision detection device having a sensor in the vehicle, and is configured to activate the airbag device for the occupant when an occurrence of a collision accident of the vehicle is detected by this sensor.

For the above-described collision detection device, there is a side collision detection device that includes a pressure sensor in a door of the vehicle to detect an occurrence of a collision on a side surface of the vehicle. This device forms a sealed space between a door outer panel and a door inner panel in the vehicle door, and detects the occurrence of the collision on the vehicle side surface by detecting a pressure change of this space in the door using the pressure sensor (see, for example, JP-A-2007-232566).

However, in the side collision detection device for a vehicle having the above-described configuration, it is difficult to enhance a sealed state of the space in the door divided with the door outer panel and the door inner panel. If this sealed state of the space in the door is low, there is an issue that accuracy in detection of a pressure change in this space by the pressure sensor is decreased and thus the occurrence of the collision on the vehicle side surface may not be detected correctly.

### SUMMARY

The present disclosure addresses at least one of the above issues. Thus, it is an objective of the present disclosure to provide a side collision detection device for a vehicle with improved accuracy in detection of a collision on a side surface of the vehicle.

To achieve the objective of the present disclosure, there is provided a side collision detection device for a vehicle, including a hollow detection tube member, a pressure sensor, and a control device. The detection tube member is arranged in a door of the vehicle. The door includes a rigid member that is provided to extend in a front-rear direction of the vehicle. The detection tube member is arranged along an outer surface of the rigid member in a width direction of the vehicle. The pressure sensor detects a pressure in the detection tube member. The control device detects a collision of an object with the door based on a result of the detection of the pressure by the pressure sensor.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating an entire configuration of a side collision detection device for a vehicle in accordance with a first embodiment;

FIG. 2 is an enlarged view illustrating inside of a left front door of the vehicle in FIG. 1;

FIG. 3 is a cross-sectional view taken along a line in FIG. 2;

FIG. 4 is a block diagram illustrating an electrical configuration according to the first embodiment;

FIG. 5 is a diagram illustrating internal structures of a detection tube and a pressure sensor according to the first embodiment;

FIG. 6A is a cross-sectional view illustrating the detection tube before a collision in the first embodiment;

FIG. 6B is a cross-sectional view illustrating the detection tube after the collision in the first embodiment;

FIG. 7 is a diagram corresponding to FIG. 5 at the time of the collision of the first embodiment; and

FIG. 8 is a diagram corresponding to FIG. 2 in accordance with a second embodiment.

### DETAILED DESCRIPTION

### First Embodiment

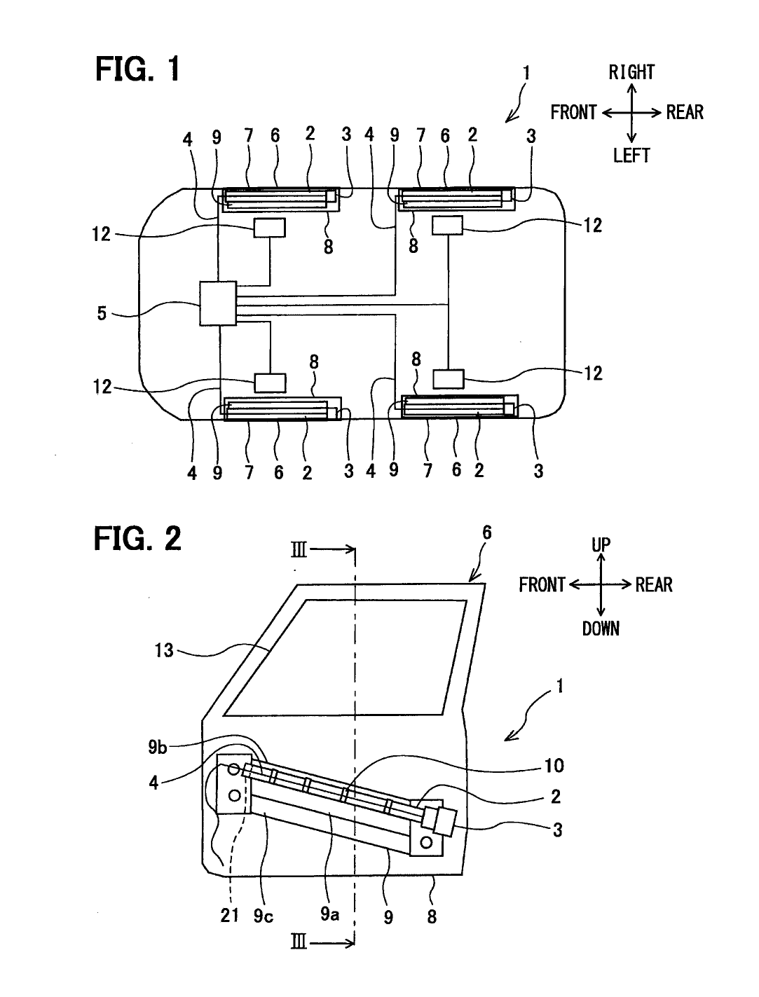

A side collision detection device for a vehicle of a first embodiment will be described below with reference to FIGS. 1 to 7. As illustrated in FIGS. 1 and 2, a side collision detection device 1 for a vehicle of the present embodiment includes a hollow detection tube member 2, a pressure sensor 3, a transmission line 4, and a collision detection ECU 5 (corresponding to a control device). This side collision detection device 1 for a vehicle detects a collision of an object M (e.g., another vehicle, obstruction, building) on a door 6 provided on a lateral side of the vehicle (see FIGS. 6A and 6B). The door 6 includes a door outer panel 7 and a door inner panel 8. These doors 6 are provided at a total of four positions, i.e., two (right and left) positions on a front side of the vehicle and two (right and left) positions on a rear side of the vehicle. An impact beam 9 is arranged between the door outer panel 7 and the door inner panel 8 in the door 6.

This impact beam 9 is provided for limiting deformation of the door 6 toward a vehicle interior when the object M collides with a side surface of the vehicle. The, impact beam 9 is a rigid member that is made of a metal member such as iron, or aluminium and has a beam shape as a whole. Specifically, the impact beam 9 includes a projecting part 9a that projects outward in a vehicle width direction, and flange parts 9b, 9c formed on both upper and lower sides from base ends of the projecting part 9a, and is formed in a hat shape in section.

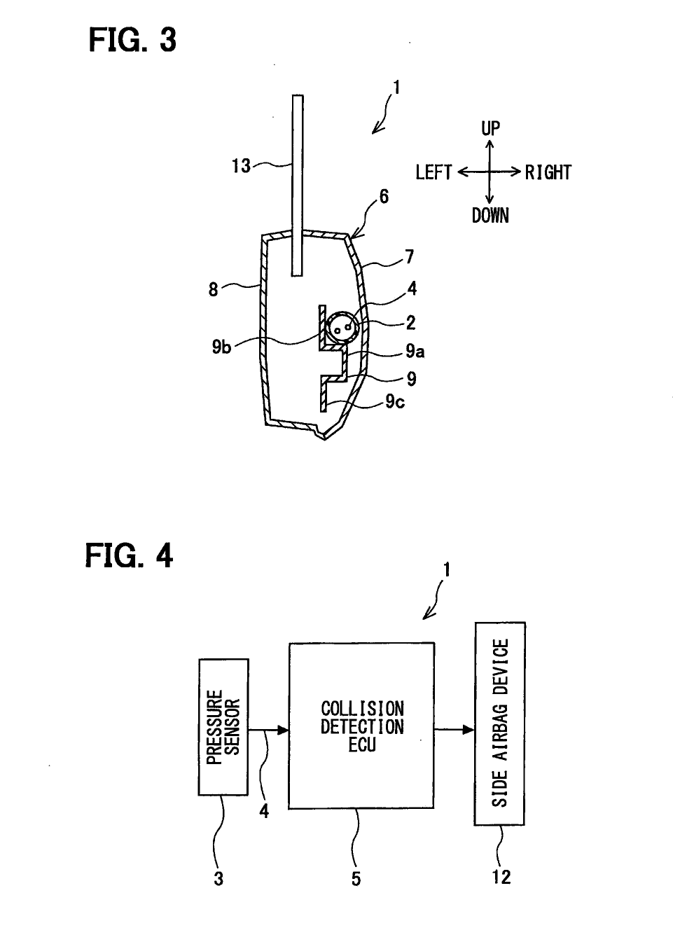

The detection tube member 2 is a member that includes therein a hollow part and extends in a front-rear direction of the vehicle as illustrated in FIGS. 2 and 3, and is arranged between the door outer panel 7 and the impact beam 9 in the door 6 of the vehicle. Specifically, the detection tube member 2 is arranged along an upper surface of the projecting part 9a of the impact beam 9 at the flange part 9b and an outer surface of the flange part 9b in the vehicle width direction, and is fixed to the impact beam 9 by a fixing member 10. In the present embodiment, bands are used for the fixing member 10, and the detection tube member 2 is fixed to the impact beam 9 at four positions by four bands. Instead of the band, for example, a clamp or adhesive may be used as the fixing member 10.

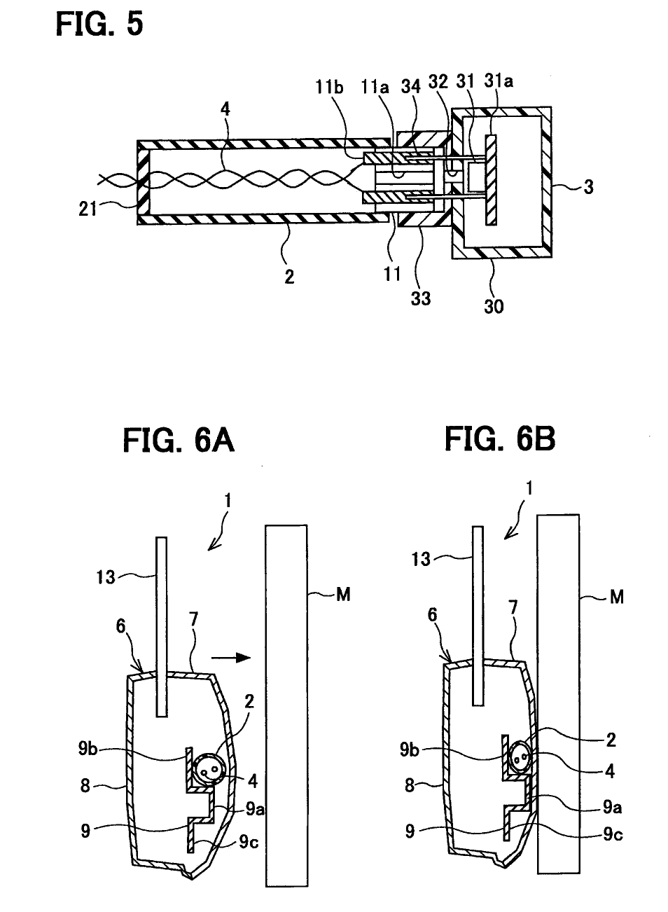

This detection tube member 2 has a round shape in cross-section, and is made from synthetic resin or synthetic rubber, for example. In the present embodiment, for example, ethylene propylene rubber (EPDM) is used for a material of the detection tube member 2. An outer diameter of the detection tube member 2 is set at, for example, approximately 10 mm. The detection tube member 2 is disposed such that its outermost surface in the vehicle width direction sticks out of the projecting part 9a in the vehicle width direction with the detection tube member 2 arranged at the flange part 9b of the impact beam 9. The outermost surface of the detection tube member 2 in the vehicle width direction may be in contact with an inner surface of the door outer panel 7. One end part of the detection tube member 2 (left end part in FIG. 5) is closed by a rubber plug 21 for sealing the inside of the detection tube member 2.

As illustrated in FIG. 1, one pressure sensor 3 is provided respectively for the two (right and left) doors 6 (front doors) on a front side of the vehicle and the two (right and left) doors 6 (rear doors) on a rear side of the vehicle. Specifically, as illustrated in FIG. 2, the pressure sensor 3 is disposed at one end part of the detection tube member 2 in a front-rear direction of the vehicle (end part on a rear side of the vehicle in FIG. 2). The pressure sensor 3 is fixed to a vehicle-side by fastening a bolt (not shown) for example.

This pressure sensor 3 is connected to the detection tube member 2 for detecting a pressure in the detection tube member 2. Specifically, the pressure sensor 3 is a sensor device that detects a pressure change of gas, and detects a pressure change of air in the detection tube member 2. As illustrated in FIG. 1, the pressure sensor 3 is electrically connected to the collision detection ECU (electronic control unit) 5 via the transmission line 4 to output a signal in proportion to the pressure to the collision detection ECU 5. The collision detection ECU 5 detects a collision of the object M into the door 6 based on a result of pressure detection by the pressure sensor 3.

As illustrated in. FIG. 5, the pressure sensor 3 includes a main body part 30, a sensor part 31, a through hole 32, a connector part 33, and a male terminal 34. The main body part 30 is a case having a box shape for accommodating the sensor part 31. The sensor part 31 includes a substrate 31a on which a sensor element for pressure detection and so forth are provided. The through hole 32 is a pipe having a generally cylindrical shape for introducing the pressure of air in the detection tube member 2 into the sensor part 31. The connector part 33 is a cylindrical member with an opening and is formed integrally with the main body part 30. The male terminal 34 extending from the substrate 31a of the sensor part 31 is accommodated in the connector part 33. More than one male terminal (two male terminals in this case) 34 are provided to extend from the substrate 31a in the main body part 30 into the connector part 33.

In the present embodiment, the pressure sensor 3 is connected to the detection tube member 2 through a connector 11. The connector 11 is a waterproof type connector that includes a through hole 11a and a female terminal 11b. The through hole 11a is a generally cylindrical pipe for introducing the pressure of air in the detection tube member 2 into the through hole 32 of the pressure sensor 3. The female terminal 11b is electrically connected to the male terminal 34 of the pressure sensor 3, and in this case, two female terminals 11b are provided corresponding to the number of male terminals 34. One end part of this connector 11 (left end part in FIG. 5) is connected to the detection tube member 2, and the other end part of the connector 11 (right end part in FIG. 5) is connected to the connector part 33 of the pressure sensor 3.

Specifically, one end part of the detection tube member 2 (right end part in FIG. 5) is attached on an outer peripheral surface of the connector 11. In this case, a sealed state in the detection tube member 2 one end part of which is closed by the rubber plug 21 is maintained. The male terminal 34 of the pressure sensor 3 is inserted and fixed in the female terminal 11b of the connector 11, and the outer peripheral surface of the connector 11 is fitted and fixed into an inner peripheral surface of the connector part 33. In this case, the through hole 32 of the pressure sensor 3 and the through hole 11a of the connector 11 are in a communicating state.

The sensor part 31 detects a pressure change in the detection tube member 2 through the through hole 11a and the through hole 32. This sensor part 31 is electrically connected to the female terminal 11b of the connector 11. The transmission line 4 is connected to one end part of the female terminal 11 b (left end part in FIG. 5).

The transmission line 4 electrically connects together the sensor part 31 of the pressure sensor 3 and the collision detection ECU 5 disposed in the vehicle. For example, a wire harness having diameter of approximately 0.5 mm is used for the transmission line 4. This transmission line 4 is arranged to extend from one end part of the detection, tube member 2 (end part on a rear side of the vehicle in FIG. 2) to the other end part of the detection tube member 2 (end part on a front side of the vehicle in FIG. 2) and to pass through the inside of the hollow of the detection tube member 2. The transmission line 4 is arranged toward the outside (collision detection ECU 5) of the detection tube member 2 through a through hole (not shown) provided for the rubber plug 21 of the detection tube member 2. The sensor part 31 of the pressure sensor 3 transmits a signal in proportion to the pressure to the collision detection ECU 5 via the male terminal 34, the female terminal 11b and the transmission line 4.

The collision detection ECU 5 is composed mainly of a CPU for controlling the overall operation of the side collision detection device 1 for a vehicle, and is electrically connected to each of the pressure sensors 3 and side airbag devices 12 (see FIG. 1). As illustrated in FIG. 4, a pressure signal (pressure data) from the pressure sensor 3 and the like are inputted into the collision detection ECU 5. The collision detection ECU 5 performs predetermined collision determination processing based on a result of pressure detection (input signal) by the pressure sensor 3, and activates the side airbag device 12 by passing a spark current through the side airbag device 12 in case of detection of a collision of the object M on the door 6.

As illustrated in FIG. 3, the door 6 includes the metal door outer panel 7 provided outside in the vehicle width direction, and the metal door inner panel 8 provided inward of this door outer panel 7 in the vehicle width direction. The door outer panel 7 and the door inner panel 8 are integrally shaped, for example, through hemming working at their vehicle lower end parts and their end parts in a front-rear direction of the vehicle to constitute a closed section. A door pane 13 is inserted between the door outer panel 7 and the door inner panel 8.

The above-described impact beam 9 is arranged between the door outer panel 7 and the door inner panel 8 in the door 6. This impact beam 9 is arranged on the door outer panel 7-side in the door 6, being inclined in an up-down direction of, the vehicle along the front-rear direction of the vehicle as illustrated in FIG. 2. Specifically, the impact beam 9 is arranged such that a rear end part (rear side of the vehicle) of the impact beam 9 is located at a lower part of the door 6 and the impact beam 9 has a descending slope toward the rear side of the vehicle.

As illustrated in FIG. 3, this impact beam 9 includes the projecting part 9a that projects to the outside in the vehicle width direction, and the flange parts 9b, 9c formed on both upper and lower sides from the base ends of this projecting part 9a, and is formed in a hat shape in section. The flange part 9b of the impact beam 9 extends to be opposed to the entire detection tube member 2. Thus, the length of the flange part 9b in an up-down direction is longer than an outer diameter of the detection tube member 2.

The side airbag device 12 is an airbag device for occupant protection at the time of a side collision, and the devices 12 are provided on side surfaces of the doors 6 facing the vehicle interior on the front and rear sides of the vehicle, or at seat backs of seats of the vehicle. This side airbag device 12 is deployed mainly between a torso part of an occupant and the door at the time of a side collision to protect the torso part of the occupant. The side airbag device 12 may include a curtain airbag that is provided along a roof side rail of the vehicle and is deployed between the vicinity of a head of the occupant and an inner side surface of the vehicle body, mainly for protecting the head of the occupant.

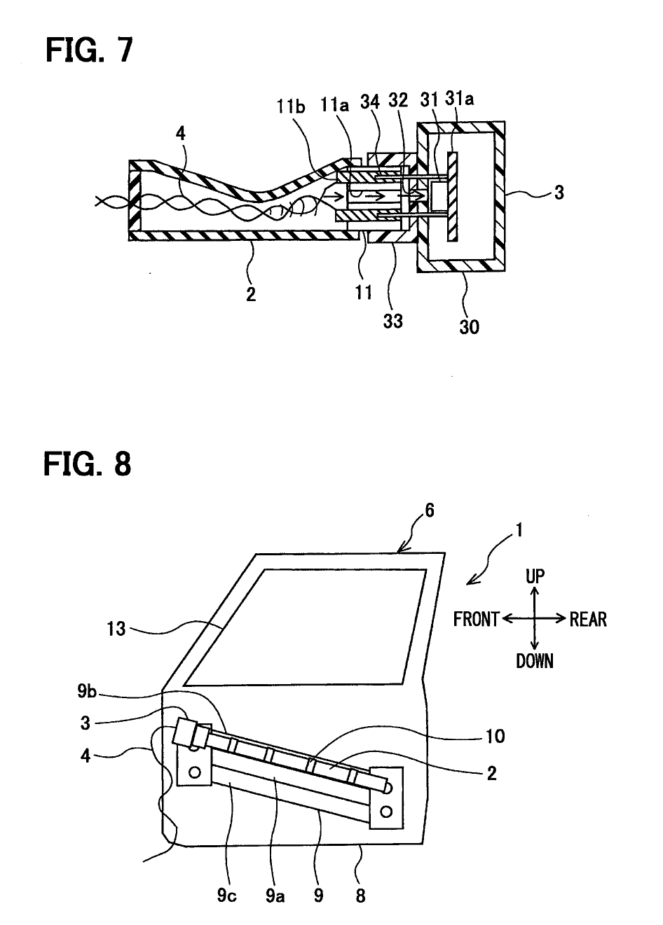

The operation of the side collision detection device 1 for a vehicle in the present embodiment at the time of a collision of the vehicle will be described below. As illustrated in FIGS. 6A and 6B, when the object M such as an obstruction collides with a side surface of the vehicle, the door outer panel 7 of the door 6 is deformed by an impact as a result of its collision with the object M (see FIG. 6B). Then, in accordance with the deformation of the door outer panel 7, the detection tube member 2 is also deformed as illustrated in FIG. 7. In this case, the pressure of air in the detection tube member 2 suddenly rises. As indicated by arrows in FIG. 7, this pressure change of air is transmitted to the sensor part 31 of the pressure sensor 3 through the through hole 11a of the connector 11 and the through hole 32 of the pressure sensor 3.

The collision detection ECU 5 of the side collision detection device 1 for a vehicle carries out the predetermined collision determination processing based on a detection result by the pressure sensor 3. In this collision determination processing, if a value of the pressure detected by the pressure sensor 3 is larger than a predetermined threshold value, it is determined that the object M (e.g., vehicle or obstruction) has collided with the door 6 of the vehicle and such a side collision as to require the operation of the side airbag device 12 has occurred. In case of the determination that the collision with the object M that requires the operation of the side airbag device 12 has occurred, the collision detection ECU 5 activates the side airbag device 12 to reduce an impact on the occupant. Alternatively, for example, a rate of pressure change per unit time may be employed for the threshold value in the collision determination processing.

As described above, the side collision detection device 1 for a vehicle of the first embodiment includes the hollow detection tube member 2 that is arranged in the door 6 of the vehicle and the pressure sensor 3 that detects the pressure in the detection tube member 2, and detects the collision of the object M on the door 6 based on a result of pressure detection by the pressure sensor 3. The first embodiment is characterized in that the door 6 includes the impact beam 9 which is a rigid member extending in the front-rear direction of the vehicle, and that the detection tube member 2 is arranged along an outer surface of the impact beam 9 in the vehicle width direction.

As a result of this configuration, the collision of the object M on the door 6 of the vehicle can be correctly detected by use of the detection tube member 2 which can easily be sealed. Accordingly, a highly sealed state of the entire space in the door 6 (space separated by the door outer panel 7 and the door inner panel 8) does not need to be maintained, and accuracy in detection of collision on a side surface of the vehicle can be improved by a simplified configuration. Moreover, because the impact beam 9 which is a rigid member is arranged inward of the detection tube member 2 in the vehicle width direction, the detection tube member 2 can be prevented from being bent inward in the vehicle width direction. Consequently, decrease of accuracy in collision detection by the detection tube member 2 can be inhibited.

The first embodiment is characterized in that the door 6 includes the door outer panel 7 provided outside in the vehicle width direction and the door inner panel 8 provided inward of this door outer panel 7 in the vehicle width direction;

the impact beam 9 which is a rigid member is arranged between the door outer panel 7 and the door inner panel 8; and that the detection tube member 2 is arranged between the door outer panel 7 and the impact beam 9.

As a result of this configuration, the detection tube member 2 can be arranged between the door outer panel 7 and the impact beam 9. Accordingly, the detection tube member 2 can be disposed at an appropriate position by means of the existing impact beam 9. Consequently, another rigid member does not need to be provided for disposing the detection tube member 2, thereby simplifying a manufacturing process of the door 6.

The first embodiment is characterized in that the impact beam 9 is formed in a hat shape in section including the projecting part 9a that projects to the outside in the vehicle width direction and the flange parts 9b, 9c formed on both upper and lower sides from the base ends of the projecting part 9a; and that the detection tube member 2 is arranged at the flange part 9b of the impact beam 9.

As a result of this configuration, the projecting part 9a of the impact beam 9 receives the door outer panel 7 which is deformed upon reception of external force from a lateral side of the vehicle when the object M collides with the door 6. Accordingly, the detection tube member 2 can be prevented from being clamped and crushed between the deformed door outer panel 7 and the impact beam 9, and the detection tube member 2 can be deformed properly.

The first embodiment is characterized in that the detection tube member 2 is arranged on an upper surface of the projecting part 9a at the flange part 9b. As a result of this configuration, by the upper surface of the projecting part 9a of the impact beam 9 supporting the lower part of the detection tube member 2, the detection tube member 2 extending in the front-rear direction of the vehicle can be prevented from being bent to the lower side of the vehicle and thereby shifted from a predetermined arrangement position. Accordingly, decrease of accuracy in collision detection by the detection tube member 2 can be inhibited.

The first embodiment is characterized in that the outermost surface of the detection tube member 2 in the vehicle width direction sticks out of the projecting part 9a in the vehicle width direction with the detection tube member 2 arranged at the flange part 9b of the impact beam 9. As a result of this configuration, the outermost surface of the detection tube member 2 in the vehicle width direction sticks out of the projecting part 9a of the impact beam 9 in the vehicle width direction. Accordingly, the door 6 which is deformed by the external force at the time of occurrence of the collision on a side surface of the vehicle can reliably be brought into contact with the detection tube member 2 before the door 6 comes into contact with the impact beam 9. Consequently, the collision of the object M on the door 6 can be detected correctly and quickly.

The first embodiment is characterized in that the detection tube member 2 is arranged along an outer surface of the impact beam 9 in the vehicle width direction and that the impact beam 9 is a rigid member opposed to this entire detection tube member 2. As a result of this configuration, the entire portion of the detection tube member 2 which is deformed by the external force can be received reliably by the impact beam 9 which is a rigid member. Accordingly, the detection tube member 2 can be prevented more certainly from being bent inwardly in the vehicle width direction.

The first embodiment is characterized in that the detection tube member 2 is fixed to the impact beam 9, which is a rigid member, by the fixing members 10. As a result of this configuration, the detection tube member 2 can stably be fixed to the impact beam 9 through the use of the fixing member 10. Accordingly, there can be prevented a shift of the detection tube member 2 from a predetermined arrangement position of the impact beam 9, or disconnection between the detection tube member 2 and the pressure sensor 3 at the time of the collision on a side surface of the vehicle. Consequently, resistance properties of the side collision detection device 1 for a vehicle against the external force can be improved.

The first embodiment is characterized in that the pressure sensor 3 is disposed at one end part of the detection tube member 2 in a front-rear direction of the vehicle. As a result of this configuration, by disposing the pressure sensor 3 at one end part of the detection tube member 2, a range of detection by the detection tube member 2 in a front-rear direction of the vehicle can be ensured.

The first embodiment is characterized in that the side collision detection device 1 includes the transmission line 4 electrically connecting together the pressure sensor 3, and the collision detection ECU 5 which is the control device disposed in the vehicle, and that the transmission line 4 is arranged from one end part to the other end part of the detection tube member 2 through the inside of the hollow of the detection tube member 2.

As a result of this configuration, for example, when the pressure sensor 3 is disposed on a rear side of the vehicle, and the transmission line 4 is arranged to the collision detection ECU 5 which is provided on a front side of the vehicle, a space for a wiring structure can be saved by passing the transmission line 4 through the inside of the hollow of the detection tube member 2.

The first embodiment is characterized in that the impact beam 9 is arranged to be inclined in an up-down direction of the vehicle. As a result of this configuration, since the detection tube member 2 is arranged along an outer surface of the impact beam 9 in the vehicle width direction, a broad range of collision detection by the detection tube member 2 can be ensured due to the inclination of the impact beam 9 in an up-down direction of the vehicle.

### Second Embodiment

A second embodiment will be described below with reference to FIG. 8. In FIG. 8, to the same part as in the above first embodiment, the same corresponding reference numeral is given to omit its description, and only different parts will be explained. In the second embodiment, as illustrated in FIG. 8, unlike the first embodiment, a pressure sensor 3 is disposed at an end part of a detection tube member 2 on a front side of the vehicle, and a transmission line 4 is arranged not to pass through the inside of the hollow of the detection tube member 2. Thus, the transmission line 4 is arranged directly to a collision detection ECU 5 without passing through the inside of the hollow of the detection tube member 2.

As a result of this configuration, effects similar to the first embodiment can be produced, and there is no need to arrange the transmission line 4 in the hollow of the detection tube member 2. Accordingly, a wiring structure can be further simplified.

The present disclosure is not limited to the above-described embodiments, and can be modified or extended in various manners without departing from the scope of the present disclosure. Modifications to the above embodiments will be described below. For example, in the above embodiments, the detection tube member 2 is arranged at the flange part 9b of the impact beam 9. Alternatively, the detection tube member 2 may be arranged outside the projecting part 9a of the impact beam 9 in the vehicle width direction. Although the impact beam 9 having a hat shape in section is employed, alternatively, an impact beam 9 having a rectangular cylindrical shape or rectangular plate shape in section may be used, and the shape and size of the impact beam 9 can be appropriately changed. Moreover, another rigid member may be provided in place of the impact beam 9, and the detection tube member 2 may be arranged outside this rigid member in the vehicle width direction.

The impact beams 9 are provided respectively for the four (right and left) doors 6 on the front and rear sides of the vehicle. Alternatively, two impact beams 9 may be arranged side by side for each door 6, and the detection tube member 2 may be provided for each impact beam 9. The impact beam 9 does not need to be inclined in an up-down direction of the vehicle, and may be provided horizontally in a front-rear direction of the vehicle.

There has been described a case in which the detection tube member 2 and the pressure sensor 3 are connected via the connector 11. Alternatively, the detection tube member 2 may be connected directly to the pressure sensor 3.

In addition, in the present embodiments, one pressure sensor 3 is arranged at one end part of the detection tube member 2. Alternatively, in order to improve redundancy, two pressure sensors 3 may be provided respectively at both end parts of the detection tube member 2.

To sum up, the side collision detection device 1 for a vehicle in the above embodiments can be described as follows.

A side collision detection device 1 for a vehicle includes a hollow detection tube member 2, a pressure sensor 3, and a control device 5. The detection tube member 2 is arranged in a door 6 of the vehicle. The door 6 includes a rigid member 9 that is provided to extend in a front-rear direction of the vehicle. The detection tube member 2 is arranged along an outer surface of the rigid member 9 in a width direction of the vehicle. The pressure sensor 3 detects a pressure in the detection tube member 2. The control device 5 detects a collision of an object M with the door 6 based on a result of the detection of the pressure by the pressure sensor 3.

As a result of this configuration, the collision of the object M on the door 6 of the vehicle can be correctly detected by use of the detection tube member 2 which can easily be sealed. Accordingly, a highly sealed state of the entire space in the door 6 does not need to be maintained, and accuracy in collision detection can be improved by a simplified configuration. Because the rigid member 9 is arranged inward of the detection tube member 2 in the vehicle width direction, the detection tube member 2 can be prevented from being bent inwardly in the vehicle width direction by the door 6 which is deformed upon reception of external force at the time of the collision between the vehicle and the object M. Consequently, decrease of accuracy in collision detection by the detection tube member 2 can be inhibited.

The door 6 may include a door outer panel 7 that is provided outside in the width direction of the vehicle, and a door inner panel 8 that is provided inward of the door outer panel 7 in the width direction of the vehicle. The rigid member 9 may be an impact beam 9 that is arranged between the door outer panel 7 and the door inner panel 8. The detection tube member 2 may be arranged between the door outer panel 7 and the impact beam 9. The rigid member 9 may be formed in a hat shape in section including a projecting part 9a that projects outward in the width direction of the vehicle and flange parts 9b, 9c that is formed on both upper and lower sides from base ends of the projecting part 9a. The detection tube member 2 may be arranged at one 9b of the flange parts 9b, 9c of the rigid member 9. The detection tube member 2 may be arranged on an upper surface of the projecting part 9a at the one 9b of the flange parts 9b, 9c. An outermost surface of the detection tube member 2 in the width direction of the vehicle may stick out of the projecting part 9a in the width direction of the vehicle with the detection tube member 2 arranged at the one 9b of the flange parts 9b, 9c of the impact beam 9. The detection tube member 2 may be arranged along an outer surface of the rigid member 9 in the width direction of the vehicle. The rigid member 9 may be opposed to the entire detection tube member 2. The side collision detection device 1 may further include a fixing member 10. The detection tube member 2 is fixed to the rigid member 9 by the fixing member 10. The pressure sensor 3 may be disposed at one end part of the detection tube member 2 in the front-rear direction of the vehicle. The control device 5 may be disposed in the vehicle. The side collision detection device 1 may further include a transmission line 4 that electrically connects together the pressure sensor 3 and the control device 5 and that is arranged from the one end part to the other end part of the detection tube member 2 through inside of a hollow part of the detection tube member 2. The rigid member 9 may be arranged to be inclined in an up-down direction of the vehicle.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A side collision detection device for a vehicle, comprising:
a hollow detection tube member that is arranged in a door of the vehicle, wherein:
the door includes a rigid member that is provided to extend in a front-rear direction of the vehicle; and
the detection tube member is arranged along an outer surface of the rigid member in a width direction of the vehicle;
a pressure sensor that detects a pressure in the detection tube member, and
a control device that detects a collision of an object with the door based on a result of the detection of the pressure by the pressure sensor.

2. The side collision detection device according to claim 1, wherein:
the door includes:
a door outer panel that is provided outside in the width direction of the vehicle; and
a door inner panel that is provided inward of the door outer panel in the width direction of the vehicle;
the rigid member is an impact beam that is arranged between the door outer panel and the door inner panel; and
the detection tube member is arranged between the door outer panel and the impact beam.

3. The side collision detection device according to claim 2, wherein:
the impact beam is formed in a hat shape in section including a projecting part that projects outward in the width direction of the vehicle and flange parts that is formed on both upper and lower sides from base ends of the projecting part; and
the detection tube member is arranged at one of the flange parts of the impact beam.

4. The side collision detection device according to claim 3, wherein the detection tube member is arranged on an upper surface of the projecting part at the one of the flange parts.

5. The side collision detection device according to claim 3, wherein an outermost surface of the detection tube member in the width direction of the vehicle sticks out of the projecting part in the width direction of the vehicle with the detection tube member arranged at the one of the flange parts of the impact beam.

6. The side collision detection device according to claim 1, wherein the detection tube member is arranged along an outer surface of the rigid member in the width direction of the vehicle, and the rigid member is opposed to the entire detection tube member.

7. The side collision detection device according to claim 1, further comprising a fixing member, wherein the detection tube member is fixed to the rigid member by the fixing member.

8. The side collision detection device according to claim 1, wherein the pressure sensor is disposed at one end part of the detection tube member in the front-rear direction of the vehicle.

9. The side collision detection device according to claim 8, wherein the control device is disposed in the vehicle, the side collision detection device further comprising a transmission line that electrically connects together the pressure sensor and the control device and that is arranged from the one end part to the other end part of the detection tube member through inside of a hollow part of the detection tube member.

10. The side collision detection device according to claim 1, wherein the rigid member is arranged to be inclined in an up-down direction of the vehicle.
